(19) United States
(12) Patent Application Publication
(10) Pub. No.: US 2024/0181703 A1
(43) Pub. Date: Jun. 6, 2024

(54) Additive Manufacturing Apparatus for Extrusion-Based Production of a Shaped Body

(71) Applicant: Bayerische Motoren Werke Aktiengesellschaft, Muenchen (DE)

(72) Inventors: Andreas REINHARDT, Furth (DE); Nevine TAGSCHERER, Muenchen (DE)

(21) Appl. No.: 18/285,053

(22) PCT Filed: Apr. 8, 2022
(86) PCT No.: PCT/EP2022/059391

§ 371 Date: Sep. 29, 2023

(30) Foreign Application Priority Data
Apr. 28, 2021 (DE) 10 2021 110 843.8

(51) Int. Cl. B29C 64/321; B29C 64/141; B29C 64/209; B33Y 10/00; B33Y 30/00; B33Y 40/10

(52) U.S. Cl. CPC B29C 64/321; B29C 64/141; B29C 64/209; B33Y 10/00; B33Y 30/00; B33Y 40/10

(57) ABSTRACT

An additive manufacturing apparatus for extrusion-based production of a shaped article starting from a build material present in the form of a granulate and/or a powder, includes a plasticizing means, a printing nozzle, and a first connecting channel. Via the first connecting channel the build material is at least temporarily conductible/conducted from an outlet of the plasticizing means to the exit opening of the printing nozzle. Via a further connecting channel build material is at least temporarily conductible/conducted to a receiving region which does not correspond to the exit opening of the printing nozzle.

### BACKGROUND

The present disclosure relates to an additive manufacturing process for extrusion-based production of a shaped article.

The prior art discloses extrusion processes which provide for a plasticization of a build material present in the form of granulate. The build material is subsequently injected into a mold having a cavity and cured to form a shaped article corresponding in shape to a negative of the cavity.

The prior art further discloses additive manufacturing processes known as fused deposition modeling (FDM) or fused filament fabrication (FFF) which provide for the use of a strand-type starting material as build material which is supplied to a heated outlet nozzle and is selectively deposited domain-dependently at/on a build plane via the outlet nozzle.

The disadvantage here is that the use of strand-type starting material/of build material in the form of a filament limits the amount of build material per unit time exiting the nozzle.

### SUMMARY

It is an object of the present disclosure to specify an apparatus which especially in respect of a simple and cost-effective measure allows acceleration of the build process while simultaneously achieving a high quality of the shaped article to be produced.

The object is achieved by an additive manufacturing apparatus for extrusion-based production of a shaped article starting from a build material present in the form of a granulate and/or a powder according to this disclosure.

The disclosure relates to an additive manufacturing apparatus for extrusion-based production of a shaped article starting from a build material present in the form of a granulate and/or a powder comprising a plasticizing means in which the powder- and/or granulate-form starting build material is plasticizable/plasticized. Extrusion-based is to be understood as meaning that a solid to viscous curable composition is continuously pressed under pressure out of a shaping nozzle/an opening also referred to as an opening or die. This makes it possible to deposit build material strands (extrudate) onto a build plane. Since the starting material employed is a build material present in the form of powder or of granulate which passes through a plasticizing means comprising a screw extruder for example, it is possible to achieve a high processing speed and a high volume flow of plasticized build material may be provided at the opening of the printing nozzle for depositing on the build plane. This makes it possible to achieve significantly higher material deposition rates (build material volume per unit time) than for an apparatus construction employing a build material in strand-type/filamentous initial form.

For plasticization the powder- and/or granulate-type or powder- and/or granulate-form build material is transferred through the plasticizing unit at a predefined pressure range and a predefined temperature range. In this plasticized form the build material is supplied to a printing nozzle having an exit opening. By means of this printing nozzle the plasticized build material is selectively and domain-dependently applied/deposited, especially layerwise, in a build plane to form the shaped article.

The additive manufacturing apparatus comprises a first connecting channel by means of which the build material is at least temporarily conductible/transferable from an outlet of the plasticizing means to the exit opening of the printing nozzle. The additive manufacturing apparatus further comprises a further connecting channel by means of which build material is at least temporarily conductible/conducted to a receiving region, wherein this receiving region does not correspond to the exit opening of the printing nozzle. In other words the additive manufacturing apparatus provides for two connecting channels, wherein a first connecting channel deposits the build material for forming the shaped article at/on the build plane via the discharge opening of the printing nozzle and a further connecting channel supplies the build material not to the printing nozzle but to a receiving region arranged spaced apart from the printing nozzle. In general terms the first connecting channel may be referred to as a main channel and the at least one further connecting channel may be referred to as a bypass since the latter bypasses the supply of the build material to the printing nozzle. In light of this it is possible to refer to a main stream of the build material via the first connecting channel and a substream of the build material via the at least one further connecting channel.

Providing for the possibility of conducting build material via the substream/by providing the further connecting channel/the bypass at least a minimum volume stream, in particular the entire volume stream, of build material may be at least temporarily conducted via the bypass so that despite non-occurrence of depositing of build material at/on the build plane via the printing nozzle the plasticizing means requires only minor adapting, if any, of its control and/or operating parameters. In other words the plasticizing means can be run in an arbitrary (high) operating mode irrespective of the amount of build material deposited via the printing nozzle since the build material propelled by the plasticizing means can be diverted via the further connecting channel/via the bypass. In other words a stopping of the plasticizing means may be prevented/the means may be allowed to run on despite the first connecting channel or main channel being closed or limited in its volume flow conveying, so that any startup- and delay-related process variations can be reduced or avoided.

The at least one further connecting channel is for example arranged or configured downstream of the outlet of the plasticizing means, wherein build material is at least temporarily conducted or conductible to a receiving region by means of the further connecting channel.

Layerwise construction can be understood as meaning that once material has been applied/deposited in a build plane, a build plate and/or a printing means comprising the printing nozzle is displaced relative to the hitherto applied build material along a vertical axis/in the Z-direction, thus resulting in a (parallel) displacement of the build plane relative to the hitherto applied build material. In this new position of the printing nozzle in the Z-direction build material is again applied in the new build plane, thus applying a further layer applied to the first layer. This process proceeds analogously to the formation of a multiplicity of layers, thus resulting in production of a shaped article produced in layerwise fashion.

A closure means may be arranged or configured in the first connecting channel, wherein the closure means is adapted for altering, in particular for controlling, a volume flow/a mass flow of the plasticized build material passed through the connecting channel. When reference is made here to an open- and/or closed-loop control means this always encompasses an at least temporary or else permanent open- and/or closed-loop control means in a relatively narrow sense. Through appropriate control of the closure means the amount of build material discharged/deposited via the printing nozzle may be between a value of 0% and 100% of the maximum possible output amount. The closure means is preferably in the form of a needle valve.

If at least one closure means is in the form of a needle valve this may be formed/configured such that it passes through all dead space in the region of the printing nozzle and thus clears any material “lingering” there. In other words in the open position of the closure means a needle-shaped closure element is entirely retracted, thus allowing an open space, in which build material is deposited, to form in the region of the retracted closure means. In the course of the design of the closure means the closure element may be moved such that it traverses the deposition site of the build material and therefore discharges any build material deposited at this site, thus obviating the need for a cleaning/maintenance process or allowing such a process to be performed less frequently.

The first connecting channel may for example have a first closure means and the at least one further connecting channel at least one further closure means arranged or configured in it, wherein the degree of opening of the closure means is controllable, in particular by open- or closed-loop control. The further closure means too may be in the form of a needle valve for example. The needle valve may comprise a needle-shaped valve plunger provided with a thread. Said plunger may for example temporarily protrude into a small opening and thus effect precise control of the flow/the volume flow of the build material passed through this opening. It may for example be provided that the at least one first valve means assigned to the main channel and the at least one further valve means assigned to the subchannel/the further connecting channel are in each case configured as a needle valve.

At least one closure means, in particular both closure means, may for example be arranged or configured close to the respective outlet site (for example outlet region/printing nozzle). As a result the closure means arranged in the first connecting channel/in the main channel may be located close to the exit opening of the printing nozzle. Analogously, a further closure means arranged in the further connecting channel/in the bypass may be located close to the outlet region of the further connecting channel/close to the receiving region. In other words at least one closure means may be in proximity/close to the printing nozzle and/or in proximity/close to the receiving region. It is preferable when the first closure means is arranged in proximity to the printing nozzle and the further closure means is arranged in proximity to the receiving region. For example the at least one closure means is arranged in proximity to the outlets (i.e. for example the printing nozzle and the outlet region of the further connecting channel) of the build material from a printing unit comprising at least one printing nozzle.

A close arrangement of the closure means is to be understood as meaning that the closure means is arranged closer to the printing nozzle/to the outlet region than to the outlet of the plasticizing means, in particular than to the outlet of a screw extruder. The closure means is, for example, arranged in the half, preferably quarter, particularly preferably sixth, most preferably tenth, of the channel route from the outlet of the plasticizing means, in particular from the outlet of the screw extruder, to the exit opening of the printing nozzle/to the outlet region of the further connecting channel facing the printing nozzle/the outlet region. It is also possible for at least one closure means to be arranged immediately upstream of the printing nozzle and/or immediately upstream of the outlet region of the further connecting channel. The resulting short paths of the build material downstream of the closure means ensure that the proportion of build material uncontrollable or controllable only to a limited extent in terms of its motion in the process can be minimized.

The opening degree/the degree of uncovered transit opening of the at least two closure means may be controllable, for example, via a control unit, i.e. by open- and/or closed-loop control. The control unit-side control of the opening degree of the at least one, in particular both, closure means may be effected continuously/steplessly for example. The, especially central, control unit may be supplied for example with (a) open- and/or closed-loop control data from a robot control means and/or a heater control means and/or a plasticizer control means and/or with (b) sensor data from manufacturing apparatus sensors (for example temperature sensor, accelerometer, optical sensor, servo motor data and/or position sensor data). An evaluation of the data supplied to the control unit is carried out for example, wherein modified open- and/or closed-loop control information may be output in particular on the basis of these supplied data. Combining the data in the control unit can make it possible for example to match the control data of a constituent of the plasticizing means in the form of a screw extruder and of the process control data of a robot such that a deactivating of the screw extruder is effected when the printing nozzle completes a relatively long path over the build plane by means of the robot without depositing build material or is correspondingly displaced. During this deactivation of the plasticizing means, in particular during deactivation of the screw extruder, both closure means may be brought into a closed position or assume a closed position, preferably under control of the control unit. A relatively long path may for example comprise at least a length which is longer than a tenth, preferably longer than a sixth, particularly preferably longer than a quarter, particularly preferably longer than a third, most preferably longer than half, of the maximum build space length in the corresponding direction.

The employed build material may for example be at least partially composed of plastics material, preferably a build material comprising a plastics material and fibers, in particular short fibers, is employed. The build material may be formed at least partially, preferably predominantly, of plastics material. A build material composed of 15% to 40% by weight of a non-plastics fiber material and a polymer matrix is employed for example. It is optionally possible to add carbon fibers, in particular short carbon fibers, to the extrusion process as a build material constituent added to a plastics granulate. Employable short fibers include fiber material which, to an extent of at least 50%, preferably to an extent of at least 75%, particularly preferably to an extent of at least 80%, most preferably to an extent of at least 85%, has a fiber length in the range from 30 to 300 micrometers. For example at least in part, preferably predominantly, particularly preferably entirely, shredded fiber remains are admixed during and/or after granulation of the build material.

The build material employed in the present process may for example comprise at least as a constituent, in particular entirely, a thermoplastic plastics material which is preferably melted at a temperature in a range between 30° C. and 420° C., in particular 180° C. to 300° C. The additive manufacturing apparatus, in particular the plasticizing means, may accordingly comprise suitable means, for example heating means, which make it possible to correspondingly heat the thermoplastic plastics material. These means may for example be in the form of a heating cartridge or in the form of a heating jacket. Employable thermoplastic plastics materials preferably include the following with the corresponding melt temperatures: polyamide 6 (PA 6) having a melt temperature in the range from 240° C. to 290° C.; polyamide 66 (PA 66) having a melt temperature in the range from 260° C. to 300° C.; polycarbonate (PC) having a melt temperature in the range from 270° C. to 320° C.; polymethylmethacrylate (PMMA) having a melt temperature in the range from 200° C. to 290° C.; polypropylene (PP) having a melt temperature in the range from 200° C. to 300° C.; polyethylene (PE) having a melt temperature in the range from 180° C. to 300° C.; polystyrene (PS) having a melt temperature in the range from 180° C. to 280° C.; styrene-acrylonitrile copolymer (SAN) having a melt temperature in the range from 200° C. to 260° C.; acrylonitrile-butadiene-styrene copolymer (ABS) having a melt temperature in the range from 200° C. to 300° C.; acrylonitrile-styrene-acrylate copolymer (ASA) having a melt temperature in the range from 200° C. to 250° C. or polyoxymethylene (POM) having a melt temperature in the range from 180° C. to 230° C.

The receiving region into which the further connecting channel opens may for example comprise a build material collection reservoir in which the build material conducted in the further connecting channel is receivable/received. Accordingly, a portion of the build material plasticized by the plasticizing means is supplied to the printing nozzle via the first connecting channel (main connecting channel) and a further portion of the plasticized build material is supplied to the build material collection reservoir. Thus in an exemplary operating mode of the manufacturing apparatus s build material may be simultaneously conveyed/conducted in the at least two connecting channels i.e. in the main connecting channel and in at least one further connecting channel. The build material collection reservoir may for example be configured as a build material collection container which is detachably connectable to the additive manufacturing apparatus so that said container may also be, especially temporarily, removed from the additive manufacturing apparatus if required. The correctly present employed state may for example be detected via a manufacturing apparatus-side sensor and a corresponding status signal transmitted to a control means for example.

The outlet region of the further connecting channel (bypass) arranged downstream of the plasticizing means is for example connected to a feed section of the plasticizing unit, so that the build material conducted by the connecting channel is suppliable/supplied to a plasticizing means-side plasticizing process for plasticizing the build material. In the words the build material not supplied to the main stream and thus discharged via the further connecting channel (substream/bypass) may be returned to the plasticizing means in order therein to be re-subjected to a plasticizing process. The build material returned to the plasticizing means may be added to or admixed with the build material supplied to the plasticizing means-side plasticizing process newly/for the first time. A granulating process performed by means of a granulating means may for example be arranged upstream of the returning of the build material conducted in the further connecting channel into the plasticizing process. Accordingly, the build material conducted in the further connecting channel may be initially shaped/processed (for example shredded) in granulate and subsequently supplied to the plasticizing means, in particular before or after a mixing with build material supplied to the plasticizing means-side for the first time.

In an advantageous embodiment it may be provided that a robot unit is adapted for carrying a printing means comprising at least the printing nozzle and moving this printing means over the build plane such that build material is selectively deposited domain-dependently on the build plane to form the shaped article. Displacing the at least one printing means comprising a printing nozzle over a build plane makes it possible to expand the size of the build space/the maximum possible dimensions of the shaped article constructed using the printing means. The robot unit may for example be configured in the form of an articulated robot.

A robot unit for moving the printing means comprising the printing nozzle may for example exhibit low-dynamic behavior. It is thus possible that due to a multiplicity of pending waypoints to be completed for a movement of the robot these waypoints are time-pressured, thus allowing “pre-planning” of only a short period ahead. It must be noted here that the plasticizing means and the build material moved by the plasticizing means is subject to a certain inertia in its operating control which does not allow adequate adapting of this operating control of the plasticizing means, in particular of the screw extruder of the plasticizing means, such that said means allows, in case of a delayed motion of the robot, a correspondingly reduced material output from the printing nozzle due to the conveying function of the plasticizing means, in particular of the screw extruder of the plasticizing means. Even when increasing the movement velocity of the robot and thus increasing the movement of the printing nozzle over the build plane it is usually not possible to effect such a swift increase in the conveying action of the plasticizing means, in particular of a screw extruder of the plasticizing means. However, specific actuation of the closure means in connection with the reserved further connecting channel/the bypass makes it possible to allow adequate control of the build material discharge from the printing nozzle. Accordingly, the closure means assigned to the main channel/the first connecting channel makes it possible to react sufficiently rapidly to a change in the displacement velocity of the printing nozzle, which is especially moved via a robot unit, with a change in the flow cross section of the closure means. Since the further connecting channel/the bypass is reserved it can conduct away the build material amount reduced in the first connecting channel/in the main channel, thus allowing rapid reduction of the build material discharged through the printing nozzle without necessitating a change in the build material conveying action of the plasticizing means, in particular of the screw extruder of the plasticizing means.

The plasticizing means may comprise for example at least one conveying and/or pressurizing means configured as a screw, in particular as a screw extruder. Alternatively or in addition to a screw or to a screw extruder the plasticizing means may comprise at least one plunger system, by means of which a pressurizing and/or a pressure control and/or a plasticizing of the powder- and/or granulate-form build material to be plasticized and/or of the plasticized build material is performable.

The plasticizing means and/or a printing means comprising at least one printing nozzle may for example be provided with a heating means/comprise a heating means by means of which thermal energy is transferable to a build material conducted in the plasticizing means and/or in the printing means. The heating means may be controllable in terms of its heating power/heating intensity and/or in terms of a site of the respective heating powers/heating intensities. This control may preferably be controlled by means of the control unit which controls at least one closure means of a connecting channel for example.

A channel section downstream of the outlet of the plasticizing means may have configured in it a branch at which the first and the at least one further connecting channel, i.e. for example the main channel and the bypass, branch off. In other words a plasticized build material supplied on the plasticizing means side is supplied to either of the first and at least one further connecting channel or to both simultaneously at this Y connection.

In an advantageous development the branch may for example have a first transit opening assigned to the first connecting channel and a second transit opening assigned to the at least one further connecting channel, wherein the first transit opening has a transit area which is greater than or equal to the transit area of the at least one second transit opening, wherein the transit area of the first transit opening is at least a factor of 1.3 times, particularly preferably at least a factor of 1.7 times and most preferably at least a factor of 2.5 times, greater than the transit area of the at least one further transit opening. Such a different configuration of the transit openings of the connecting channels makes it possible in an operating mode in which the build material is simultaneously passed through both connecting channels to establish a predetermined volume flow of build material for the respective connecting channels. This establishing can be made possible for example even when a closure means is arranged only in one of the two connecting channels, in particular in the first connecting channel/in the main connecting channel leading to the printing nozzle.

The additive manufacturing apparatus is adapted for extruding a powder- and/or granulate-form build material, wherein a process according to an “extrusion additive manufacturing” process (EAM) and/or “fused deposition modeling” process (FDM) and/or “fused filament fabrication” process (FFF) and/or “fused layer modeling” process (FLM) is performed. The respective process provides for an extruding processing of the powder- and/or granulate-form build material or the build material passes through a corresponding extrusion process step before it is selectively deposited domain-dependently on the build plane to form the shaped article. An initially powder- or granulate-form build material is initially plasticized by means of the plasticizing means and supplied to a printing nozzle, wherein the printing nozzle selectively deposits the plasticized build material domain-dependently on a build plane to form the shaped article. The build material discharged from the printing nozzle cures in the region of the build plane and solidifies, thus generating a shaped article in its shape.

In addition to the additive manufacturing apparatus the disclosure also relates to a process for additive manufacturing of at least one shaped article using an additive manufacturing apparatus described herein. A preferred embodiment of the process may comprise the simultaneous or alternating transit/transport of build material through the first connecting channel to a printing nozzle and through at least one further connecting channel to a receiving region.

In an advantageous development of the process it may be provided for example that a first closure means controls the supplying of plasticized build material to the exit opening of the printing nozzle and a further closure means controls the supplying of plasticized build material to a receiving region. It is preferable when in the state of an at least partially, in particular completely, closed first closure means and an at least partially, in particular completely, open further closure means that the supplying of at least a portion of the build material, preferably the supplying of the entirety of the build material, to the receiving region is performed via the further connecting channel.

Alternatively or in addition it may be provided that, when the supplying of plasticized build material to the exit opening of the printing nozzle is controllable by means of a closure means, in a state of an entirely closed first closure means the supplying of build material to the receiving region may be performed via the at least one further connecting channel, wherein the further connecting channel may itself comprise an, especially controllable, closure means or not be provided with a closure means, so that said channel is always available for conducting build material. Irrespective of whether the further connecting channel comprises a closure means it is possible to realize the advantage that the plasticizing means, in particular a screw extruder of a plasticizing means, can continue to run, preferably constantly or at a defined minimum speed even when no build material is discharged from the printing nozzle/applied. In particular an abrupt stopping and restarting and the associated delay/inertia of the overall system are at least reduced since the plasticizing means can continue to run outright or at least at a minimum level in terms of its build material conveying function.

All advantages, details, embodiments and/or features of the additive manufacturing apparatus according to the disclosure are transferable/applicable to the process according to the disclosure.

The disclosure is more particularly elucidated by way of example in the drawing, in which:

### BRIEF DESCRIPTION OF THE DRAWING

FIG. 1 shows an in-principle representation of an additive manufacturing apparatus.

### DETAILED DESCRIPTION

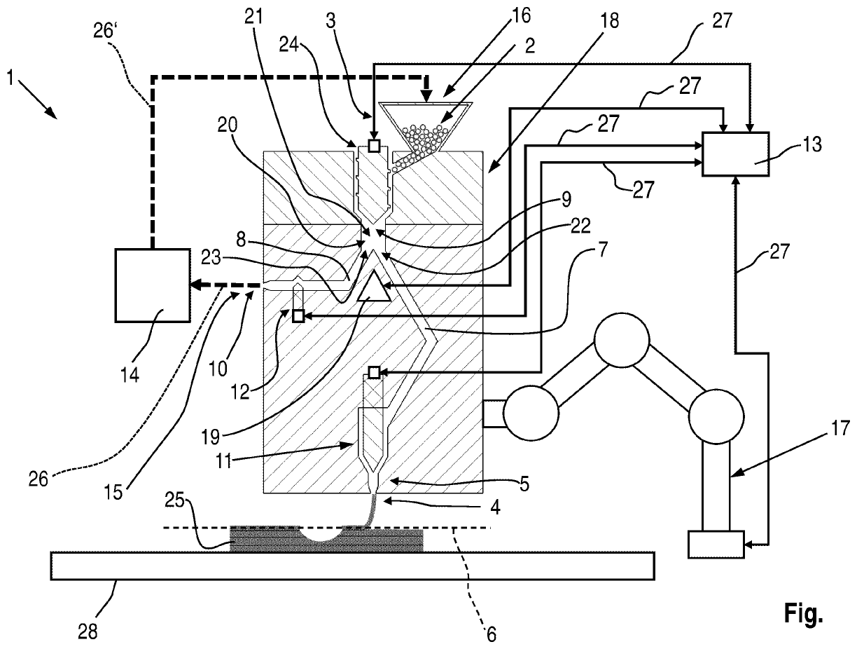

FIG. 1 shows an additive manufacturing apparatus 1 for extrusion-based production of a shaped article 25 starting from a granulate- and/or powder-form build material 2 comprising a plasticizing means 3 in which the powder- and/or granulate-form build material 2 is plasticizable/plasticized. The plasticizing means 3 comprises a container (see feed section 16) in which the granulate is received and passed to a screw extruder 24. By means of a printing nozzle 5 provided with an exit opening 4 the plasticized build material 2 is selectively applied domain-dependently in a build plane 6 to form the shaped article 25. A first connecting channel 7 (main channel) at least temporarily passes the build material 2 from an outlet 9 of the plasticizing means 3 to the exit opening 4 of the printing nozzle 5. A further connecting channel 8 (bypass) is further provided, by means of which build material 2 is at least temporarily or always passable/passed to a receiving region 10 not corresponding to the exit opening 4 of the printing nozzle 5. The receiving region 10 may already be in the form of an opening of a nozzle (not shown) which is located at the end of the further connecting channel 7 and discharges/releases the build material 2 from a metering means 18 comprising the printing nozzle 9 while not itself forming the printing nozzle 9 for construction of the shaped article 25. This nozzle/the receiving region 10 may for example form an open space into which the build material 2 from this nozzle passes, in particular at any desired site of a build space.

The first connecting channel 7 may have a (first) closure means 11 arranged or configured in it, wherein the closure means 11 is adapted for (specific) altering/adjusting of the volume flow/a mass flow of the plasticized build material 2 passed through the connecting channel 7. This altering of the volume/mass flow of the build material 2 passed through the first connecting channel 7 may comprise a controlling, in particular an open- or closed-loop controlling.

In the exemplary embodiment shown the first connecting channel 7 may have a first closure means 11 arranged or configured in it and the at least one further connecting channel 8 may have at least one further closure means 12 arranged or configured in it. The opening degree of the closure means 11, 12 may be controllable/controlled. The first and/or the at least one further closure means 11, 12 may be controlled, in particular by open- or closed-loop control, between an entirely open and an entirely closed operating position in a stepped or stepless fashion. The first closure means 11 and/or the second closure means 12 may be in the form of a needle valve for example.

The opening degree of the at least two closure means 11, 12 may be controllable, in particular by open- and/or closed-loop control, via a control unit 13, for example. To this end the control unit 13 is connected to the at least one closure means 11, 12 via a uni- or bidirectional data connection 27.

The use of two closure means 11, 12 can also result in avoidance of larger jumps in cross-section within the channel sections conducting the build material 2 since the bypass allows continuous operation during a change in the outlet amount of the build material 2. This results in lower resistances and a more uniformly operating overall process.

The employed build material 2 may for example be composed at least partially of plastics material, preferably a build material 2 comprising plastics and fibers is employed, wherein fibers are supplied to the plastics granulate and together processed into the plasticized build material 2 in the course of the plasticizing means-side plasticizing process.

Curing of the build material 2 can afford a shaped article 25 reinforced by the incorporated fibers. The fibers employed may be short fibers for example.

The receiving region 10 into or onto which the further connecting channel 8 opens may for example comprise a build material collection reservoir 14 in which the build material 2 conducted in the further connecting channel 8 is receivable/received.

The at least one closure means 11, 12 may preferably be arranged in proximity to/in the vicinity of the pressure nozzle 5 and/or in proximity to/in the vicinity of the receiving region 10. It may further be provided that the first closure means 11 is arranged in proximity to the printing nozzle 5 and the further closure means 12 is arranged in proximity to the receiving region 10. In other words the closure means 11, 12 may be in the edge region/near the outer boundary of the printing means 18/the printing head. This allows the path of the build material from the closure means 11, 12 to the outlet of the printing means 18/the printing head to be kept short.

The further connecting channel 8 with its outlet region 15 arranged downstream of the plasticizing means 3 may for example be connected to a feed section 16 of the plasticizing means 3 so that the build material 2 conducted by the connecting channel 8 is suppliable/supplied to a plasticizing means-side plasticizing process for plasticizing the build material 2. In the FIGURE this is represented by the arrows 26, 26′ representing a material flow. This material flow may for example be effected by a channel-like connection through which the build material 2 starting from the receiving region 10 is brought to the feed section 16 of the plasticizing means 3; this may be effected using a conveying means (for example a pump or the like) in particular. In this case the feed section 16 may for example partly form the build material collection reservoir 14 as an outlet region 15/receiving region 10 of the build material 2 conducted in the further connecting channel 8. Alternatively the build material collection reservoir may be configured as a build material collection container detachably arranged in the additive manufacturing apparatus 1 which is manually or automatically brought to the feed section 16 of the plasticizing means 3 and there emptied or employed such that the build material 2 present therein is supplied/suppliable to the plasticizing means-side plasticizing process.

Before recycling of the build material 2 that is passed through the further connecting channel 8/the bypass this may be pulverized and/or granulated so that said build material 2 may then be returned to the plasticizing means 3 in the form of a powder and/or a granulate.

The additive manufacturing apparatus 1 may further comprise a robot unit 17 which is adapted for carrying a printing means 18 comprising at least the printing nozzle 5 and moving this printing means 18 over the build plane 6 such that build material 2 can be selectively deposited domain-dependently on the build plane 6 for layerwise formation of the shaped article 25.

The plasticizing means 3 may for example comprise at least one conveying and/or pressurizing means in the form of a screw, in particular in the form of a screw extruder 24.

Alternatively or in addition the plasticizing means 3 and/or a printing means 18 comprising at least one printing nozzle 5 may be provided with/may comprise a heating means 19. The heating means 19 is by way of example shown as a heating means arranged in the printing means 18. Alternatively or in addition the heating means may be in the form of a heating jacket (not shown) arranged or configured in or on the printing nozzle 5 and/or in or on the printing means 18 and/or in or on the plasticizing means 3. The heating jacket may at least in sections, in particular completely, circumferentially encompass an element of the additive manufacturing apparatus 1. A build material 2 passed into the plasticizing means 3 and/or into the printing means 18 may be heated by means of the thermal energy emitted by the heating means 19. It is advantageous when the heating means 19 allows heating of build material 2 conducted in the first and/or in the second connecting channel 7, 8. The heating means 19 may particularly preferably be controllable by open- or closed-loop control such that specific alteration of the temperatures of the first and the further connecting channel 7, 8 is possible. The heating means 19 may especially be controlled, in particular by open- or closed-loop control, via the control unit 13. This makes it possible to adjust the flow resistance of the build material 2 in the first connecting channel 1/the main channel leading to the pressure nozzle 5 and the at least one further connecting channel 12/the bypass on account of a specific temperature control of the build material 2 conducted in the respective connecting channels 7, 8 so that the provision of a first and/or a further closure means 11, 12 is potentially eschewable and/or in addition to a displacing of the closure means 11, 12 at least partially provided in the connecting channels 7, 8 the flow rates may additionally be specifically influenced via the temperature control means 16. This is to be understood as meaning for example that the volume flow of the build material 2 passing through the respective connecting channel 7, 8 is influenceable/adjustable via specific adjustment of the temperature control thereof in the respective connecting channels 7, 8. This allows defined specific adjustment for example of a temperature difference and thus a different viscosity and thus a different volume flow between the build material 2 flowing through the main channel and the bypass through appropriate control of the heating means 19.

In a channel section 20 downstream of the outlet 9 of the plasticizing means 3 there may be configured for example a branch 21 where the first and the at least one further connecting channel 7, 8 branch off. The transit area of the channel section 20 may be equal to or larger than the total transit area of the first and the at least one further connecting channel 7, 8.

The branch 21 may for example comprise a first transit opening 22 assigned to the first connecting channel 7 and a second transit opening 23 assigned to the at least one further connecting channel 8, wherein the first transit opening 22 has a transit area which is larger than or equal to the transit area of the at least one second transit opening 23. The transit area of the first transit opening 22 is preferably at least 1.3 times, particularly preferably at least 1.7 times, most preferably at least 2.5 times, greater than the transit area of the at least one further transit opening 23. The reported values can refer to minimum transit area values or average transit area mean values (for example arithmetic mean or median) of the respective connecting channels 11, 12 with the exception of any nozzle-like outlet region.

The additive manufacturing apparatus 1 may, for example, be operated to perform an extrusion additive manufacturing process (EAM) and/or fused deposition modelling process (FDM) and/or fused filament fabrication process (FFF) and/or fused layer modelling process (FLM), wherein a powder- and/or granulate-form build material 2 is extruded within the additive manufacturing apparatus 1 and then, especially shortly before depositing, deposited on the build plane 6 to form the shaped article 25 on a build plate 28 or on build material 2 already applied to the build plate 28.

The disclosure is further directed to a process for additive manufacturing of at least one shaped article 25 using an additive manufacturing apparatus 1 described herein. In an optional embodiment of the process the supply of plasticized build material 2 to the exit opening 4 of the pressure nozzle 5 may be controlled by means of a first closure means 11 and the supplying of plasticized build material 2 to a receiving region 10 may be controlled by means of a further closure means 12. It is further possible that in the state of a closed first closure means 11 and open further closure means 12 the supplying of at least a portion of the build material 2, in particular the supplying of the entirety of the build material 2, to the receiving region 10 may be performed via the further connecting channel 8.

The control unit 13 may for example be utilized for actuating the at least two closure means 11, 12 of the connecting channels 7, 8; to this end closure means 11, 12 may be provided with corresponding actuators actuable by means of the control unit 13. The control unit 13 may further comprise an (a) uni- or bidirectional and/or (b) wired or wireless data connection 27 to the robot unit 17 and/or to the plasticizing means 3, in particular to a screw extruder 24 of the plasticizing means 3, and/or to at least one heating means 19. In other words, the control unit 13 makes it possible to perform/effect open- and/or closed-loop control of the operation of the closure means 11, 12, of the robot unit 17, of the plasticizing means 3, in particular of the screw extruder 24 of the plasticizing means 3, and/or of the at least one heating means 18.

### LIST OF REFERENCE NUMERALS

1 additive manufacturing apparatus
2 build material
3 plasticizing means
4 exit opening of 5
5 printing nozzle
6 build plane
7 first connecting channel
8 further connecting channel
9 outlet of 3
10 receiving region
11 closure means of 7
12 closure means of 8
13 control unit
14 build material collection reservoir
15 outlet region of 8
16 feed section of 3
17 robot unit
18 printing means
19 heating means
20 channel section
21 branch
22 first transit opening of 7
23 further transit opening of 8
24 screw extruder
25 shaped article
26, 26′ arrow
27 data connection
28 build plate

1.-15. (canceled)

16. An additive manufacturing apparatus for extrusion-based production of a shaped article starting from a build material present in the form of a granulate and/or a powder, comprising:
a plasticizing means in which the powder and/or granulate-form build material is plasticizable/plasticized;
a printing nozzle provided with an exit opening via which the plasticized build material is selectively depositable/deposited domain-dependently in a build plane to form the shaped article; and
a first connecting channel via which the build material is at least temporarily conductible/conducted from an outlet of the plasticizing means to the exit opening of the printing nozzle, and a further connecting channel via which build material is at least temporarily conductible/conducted to a receiving region which does not correspond to the exit opening of the printing nozzle.

17. The additive manufacturing apparatus according to claim 16, further comprising: a closure means that is arranged or configured in the first connecting channel, wherein the closure means is configured to control a volume flow of the plasticized build material passed through the connecting channel.

18. The additive manufacturing apparatus according to claim 17, wherein the closure means is a needle valve.

19. The additive manufacturing apparatus according to claim 18, wherein the first connecting channel has a first closure means and the at least one further connecting channel at least one further closure means arranged or configured in it, and an opening degree of the closure means is controllable.

20. The additive manufacturing apparatus according to claim 19, wherein at least the further closure means is a needle valve.

21. The additive manufacturing apparatus according to claim 20, wherein the opening degree of the at least two closure means is controllable by open- and/or closed-loop control, via a control unit.

22. The additive manufacturing apparatus according to according to claim 21, wherein an employed build material is at least partially composed of plastics material.

23. The additive manufacturing apparatus according to claim 22, wherein the build material comprises short fibers.

24. The additive manufacturing apparatus according to claim 23, wherein the receiving region into which the further connecting channel opens, comprises a build material collection reservoir in which the build material conducted in the further connecting channel is receivable/received.

25. The additive manufacturing apparatus according to claim 24, wherein the build material collection reservoir is configured as a build material collection container which is detachably connectable to the additive manufacturing apparatus.

26. The additive manufacturing apparatus according to claim 25, wherein the outlet region of the further connecting channel arranged downstream of the plasticizing means is connected to a feed section of the plasticizing means, so that the build material conducted by the connecting channel is suppliable/supplied to a plasticizing means-side plasticizing process for plasticizing the build material.

27. The additive manufacturing apparatus according to claim 26, further comprising: a robot unit that is configured to carry a printing means comprising at least the printing nozzle and moving this printing means over the build plane, such that build material is selectively deposited domain-dependently on the build plane to form the shaped article.

28. The additive manufacturing apparatus according to claim 27, wherein the plasticizing means comprises at least one conveying and/or pressurizing means in the form of a screw

29. The additive manufacturing apparatus according to claim 28, wherein the screw is a screw extruder.

30. The additive manufacturing apparatus according to claim 29, wherein the plasticizing means and/or a printing means comprising at least one printing nozzle is provided with a heating means via which thermal energy is transferable to a build material conducted in the plasticizing means and/or in the printing means.

31. The additive manufacturing apparatus according to claim 30, wherein a channel section downstream of the outlet of the plasticizing means has configured therein a branch at which the first and the at least one further connecting channel branch off.

32. The additive manufacturing apparatus according to claim 31, wherein at least one closure means is arranged in proximity to the printing nozzle and/or in proximity to the receiving region.

33. The additive manufacturing apparatus according to claim 32, wherein the first closure means is arranged in proximity to the printing nozzle and the further closure means is arranged in proximity to the receiving region.

34. The additive manufacturing apparatus according to claim 33, wherein the additive manufacturing apparatus is configured to extrude a powder- and/or granulate-form build material according to an extrusion additive manufacturing process (EAM), and/or fused deposition modelling process (FDM), and/or fused filament fabrication process (FFF), and/or fused layer modelling process (FLM).

35. A process for additive manufacturing of at least one shaped article using an additive manufacturing apparatus according to claim 34, wherein a first closure means controls the supplying of plasticized build material to the exit opening of the printing nozzle and a further closure means controls the supplying of plasticized build material to a receiving region, and wherein when in the state of a closed first closure means and an open further closure means the supplying of an entirety of the build material, to the receiving region is performed via the further connecting channel.
